(19) United States
(12) Patent Application Publication
(10) Pub. No.: US 2021/0374119 A1
(43) Pub. Date: Dec. 2, 2021

(54) DATA UPDATE APPARATUS AND DATA UPDATE METHOD

(71) Applicant: FUJITSU LIMITED, Kawasaki-shi (JP)

(72) Inventor: Chihiro Kato, Kawasaki (JP)

(73) Assignee: FUJITSU LIMITED, Kawasaki-shi (JP)

(21) Appl. No.: 17/207,788

(22) Filed: Mar. 22, 2021

(30) Foreign Application Priority Data
May 26, 2020 (JP) 2020-091796

(51) Int. Cl. G06F 16/23; G06F 16/242

(52) U.S. Cl. CPC G06F 16/2358; G06F 16/2425; G06F 16/235; G06F 16/2379

(57) ABSTRACT

A non-transitory computer-readable recording medium having stored a program that causes a computer to execute a process, the process includes determining, when an update of data in a first database of a data supply source is detected, whether or not first data of an update target after the update is second data of an access control target, and changing a query related to the first data to be output to a second database of a data supply destination, based on a result of the determining.

### CROSS-REFERENCE TO RELATED APPLICATION

This application is based upon and claims the benefit of priority of the prior Japanese Patent Application No. 2020-91796, filed on May 26, 2020, the entire contents of which are incorporated herein by reference.

### FIELD

The embodiments discussed herein are related to a data update apparatus and a data update method.

### BACKGROUND

Analysis on data by data scientists and reflection in business are very important for companies. In recent days, analysis is not performed in one company alone, but companies exchange various data, and it is important to utilize the data in the business of its own company. However, for a company to provide data to such a platform, protection is demanded on data managed by the provider. Thus, a scheme for providing only data authorized by the provider to a user is demanded.

Japanese Laid-open Patent Publication No. 2017-76229 and Japanese Laid-open Patent Publication No. 2009-116846 are examples of related art.

### SUMMARY

According to an aspect of the embodiments, a non-transitory computer-readable recording medium having stored a program that causes a computer to execute a process, the process includes determining, when an update of data in a first database of a data supply source is detected, whether or not first data of an update target after the update is second data of an access control target, and changing a query related to the first data to be output to a second database of a data supply destination, based on a result of the determining.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a data provision system according to First Embodiment;

FIG. 2 is a block diagram illustrating an example of a functional configuration of a provider-side server and a user-side server;

FIG. 3 is an explanatory diagram illustrating an example of a table configuration of a provider-side RDB and a user-side RDB;

FIG. 4 is an explanatory diagram illustrating an example of a file of a provision condition;

FIG. 5 is an explanatory diagram illustrating an example of a file of another provision condition;

FIG. 6A is an explanatory diagram illustrating an example of a query change operation when information use (FALSE→TRUE) of the data provision system is updated;

FIG. 6B is an explanatory diagram illustrating an example of the query change operation when the information use (TRUE→FALSE) of the data provision system is updated;

FIG. 6C is an explanatory diagram illustrating an example of the query change operation when data is deleted in the data provision system;

FIG. 6D is an explanatory diagram illustrating an example of the query change operation when data is inserted in the data provision system;

FIG. 7 is a flowchart illustrating an example of a processing operation of a query change unit related to data update processing;

FIG. 8 is an explanatory diagram illustrating an example of the data provision system according to Second Embodiment;

FIG. 9 is an explanatory diagram illustrating an example of a computer that executes data update programs;

FIG. 10 is an explanatory diagram illustrating an example of a first data provision system;

FIG. 11 is an explanatory diagram illustrating an example of an issue of the first data provision system;

FIG. 12 is an explanatory diagram illustrating an example of a second data provision system;

FIG. 13 is an explanatory diagram illustrating an example of a third data provision system;

FIG. 14 is an explanatory diagram illustrating an example of a fourth data provision system;

FIG. 15 is an explanatory diagram illustrating an example of a fifth data provision system; and

FIG. 16 is an explanatory diagram illustrating an example of an issue of the fifth data provision system.

### DESCRIPTION OF EMBODIMENTS

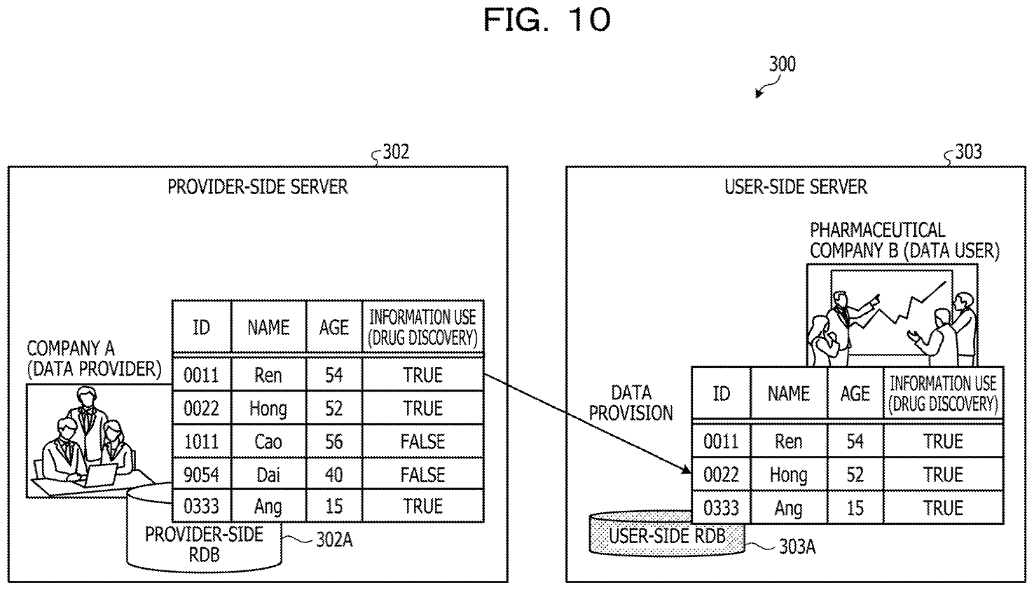

When a provider provides data stored, for example, in a relational database (RDB) to a user, authorized data is not provided in units of files but is provided in units of rows and in units of columns. FIG. 10 is an explanatory diagram illustrating an example of a first data provision system 300.

The first data provision system 300 illustrated in FIG. 10 has a provider-side server 302 and a user-side server 303. The provider is, for example, a company A that manages personal data, and the user is, for example, a pharmaceutical company B. For example, a case is supposed where the company A provides only data such as personal information authorized for use for drug discovery to the pharmaceutical company B.

The provider-side server 302 is a server that manages a provider-side RDB 302A that stores provider-side data. The provider-side RDB 302A associates and manages IDs, names, ages, and information use. The ID is an identifier for identifying personal data. The name is a name for identifying an individual. The age is an age of the individual. The information use is information for identifying whether or not information use of the personal data is authorized. Regarding the information use, “TRUE” indicates data that may be provided to the user, or “FALSE” indicates data that is not to be provided to the user. The user-side server 303 is a server that manages a user-side RDB 303A that stores user-side data.

The provider-side server 302 extracts the data with the information use “TRUE” from the provider-side RDB 302A, for example, the data with the IDs “0011”, “0022”, and “0333” and information use “TRUE” from the provider-side RDB 302A. The provider-side server 302 transmits the extracted data with the information use “TRUE” to the user-side server 303. When the data with the information use “TRUE” is received from the provider-side server 302, the user-side server 303 registers the data with the information use “TRUE” in the user-side RDB 303A. As a result, the user-side server 303 may use the data with the information use “TRUE” provided from the provider-side server 302.

Depending on contract contents (provision contents) between two companies or a type of data, it is also conceivable to update, insert, or delete data in the provider-side RDB 302A. Not only reflection of latest data but also use of sensitive data such as personal information may be suddenly disallowed due to an intention of its date owner. For example, a case is also conceivable where the information use of the ID “0011” in the provider-side RDB 302A is changed from “TRUE” to “FALSE”.

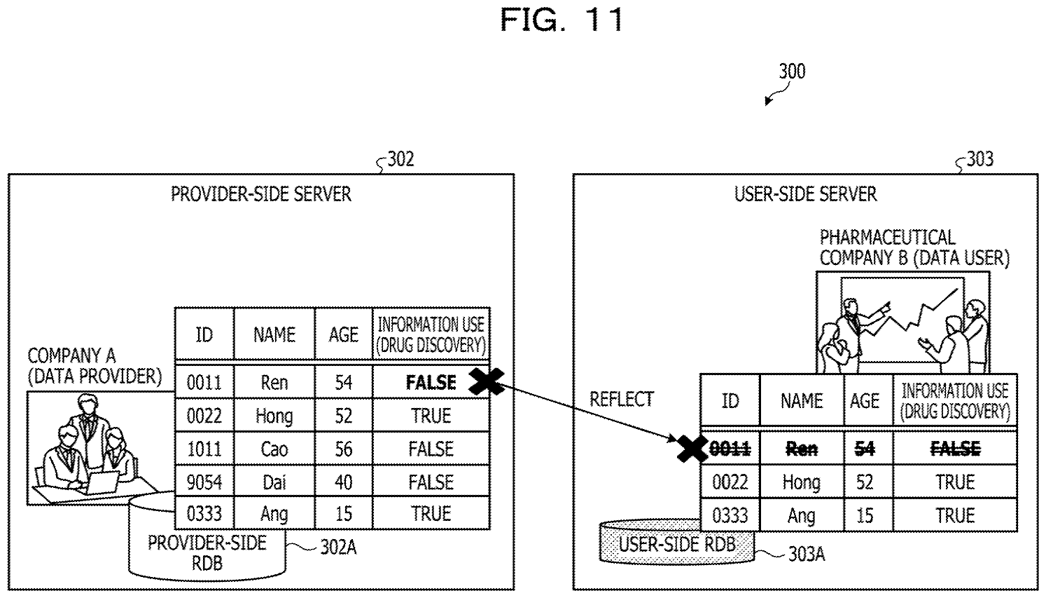

FIG. 11 is an explanatory diagram illustrating an example of an issue of the first data provision system 300. When the information use of the ID

in the provider-side RDB 302A is changed from “TRUE” to “FALSE”, the data with the ID “0011” is to be deleted from the user-side RDB 303A. For example, the contents of the user-side RDB 303A are to be updated according to update, addition, or deletion of contents of the provider-side RDB 302A, but an actual condition is that the updated contents of the provider-side RDB 302A are not reflected in the user-side RDB 303A.

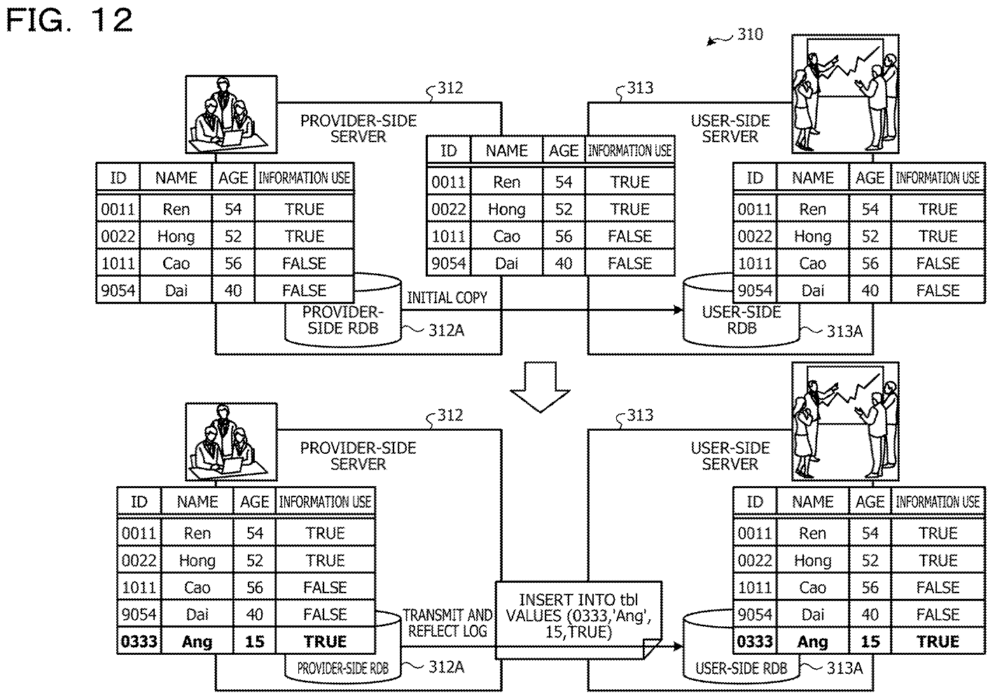

Thus, to deal with such a situation, a second data provision system 310 of logical replication which may reflect the updated contents of the provider-side RDB 302A in the user-side RDB 303A has been proposed. FIG. 12 is an explanatory diagram illustrating an example of the second data provision system 310.

The second data provision system 310 has a provider-side server 312 having a provider-side RDB 312A, and a user-side server 313 having a user-side RDB 313A. For convenience of descriptions, for example, the provider-side RDB 312A stores the data with the IDs “0011” and “0022” and information use “TRUE”, and the data with the IDs “1011” and “9054” and information use “FALSE”.

First, the provider-side server 312 transmits a copy of the data stored in the provider-side RDB 312A to the user-side server 313. The user-side server 313 stores the copy of the data stored in the provider-side RDB 312A in the user-side RDB 313A.

When new data, for example, data with the ID “0333”, name “Ang”, age “15”, and information use “TRUE” is added in the provider-side RDB 312A, the provider-side server 312 transmits insertion log information to the user-side server 313. The insertion log information is, for example, insertion log information including the data with the ID “0333”, name “Ang”, age “15”, and information use “TRUE”.

When the insertion log information is received, the user-side server 313 analyzes contents of the insertion log information and inserts the data with the ID “0333”, name “Ang”, age “15”, and information use “TRUE” in the user-side RDB 313A. For example, when the log included in a log type such as update, deletion, or insertion of the contents in the provider-side RDB 312A is obtained, the provider-side server 312 notifies the user-side server 313 of the obtained log information. As a result, according to the update of the contents of the provider-side RDB 312A, difference contents of the provider-side RDB 312A may be reflected in the contents of the user-side RDB 313A.

The second data provision system 310 is a system used for backup such that the contents of the provider-side RDB 312A are identical to the contents of the user-side RDB 313A. However, the system is not applied to a filtering function for providing only the data with the information use “TRUE” authorized by the provider-side server 312 to the user-side RDB 313A.

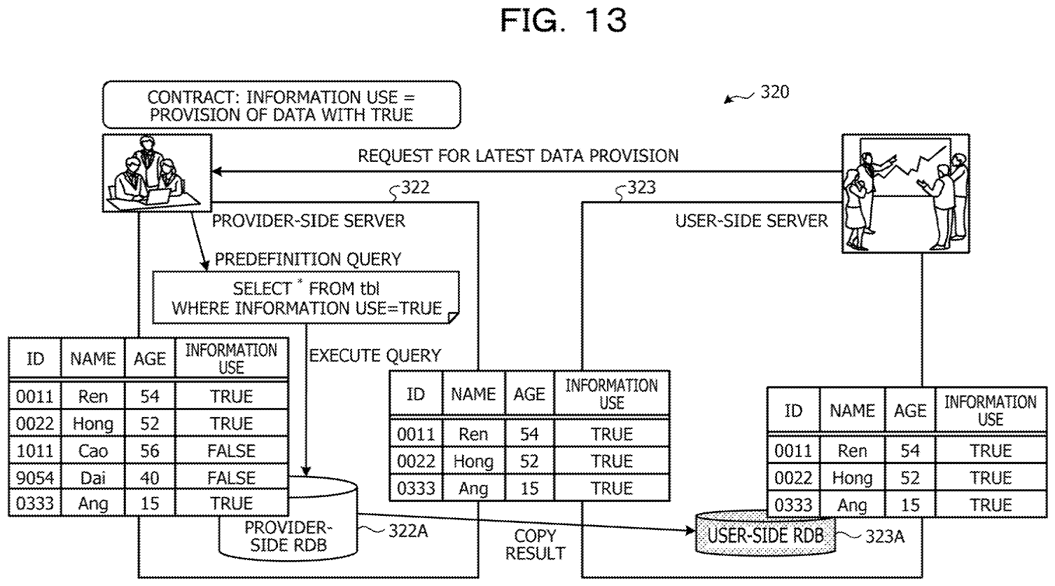

Thus, to cope with such a situation, a third data provision system 320 that sets a predefinition query as a data provision condition is conceivable. FIG. 13 is an explanatory diagram illustrating an example of the third data provision system 320. The third data provision system 320 illustrated in FIG. 13 has a provider-side server 322 having a provider-side RDB 322A, and a user-side server 323 having a user-side RDB 323A.

The provider-side server 322 extracts only the data with the information use “TRUE” from the provider-side RDB 322A according to the predefinition query. The predefinition query is a data provision condition for extracting only the data with the information use “TRUE” to be provided to the user-side server 323. The provider-side server 322 transmits the extracted data with the information use “TRUE” to the user-side server 323. The user-side server 323 registers the extracted data with the information use “TRUE” in the user-side RDB 323A. As a result, the provider-side server 322 may realize a filtering function with which only the data authorized according to the predefinition query may be provided to the user-side server 323.

However, each time update, deletion, or insertion of the contents in the provider-side RDB 322A is performed, the provider-side server 322 is to perform processing for extracting the data according to the predefinition query from all data in the provider-side RDB 322A. Since the provider-side server 322 also transmits the authorized data corresponding to the extraction result to the user-side server 323, processing load is large.

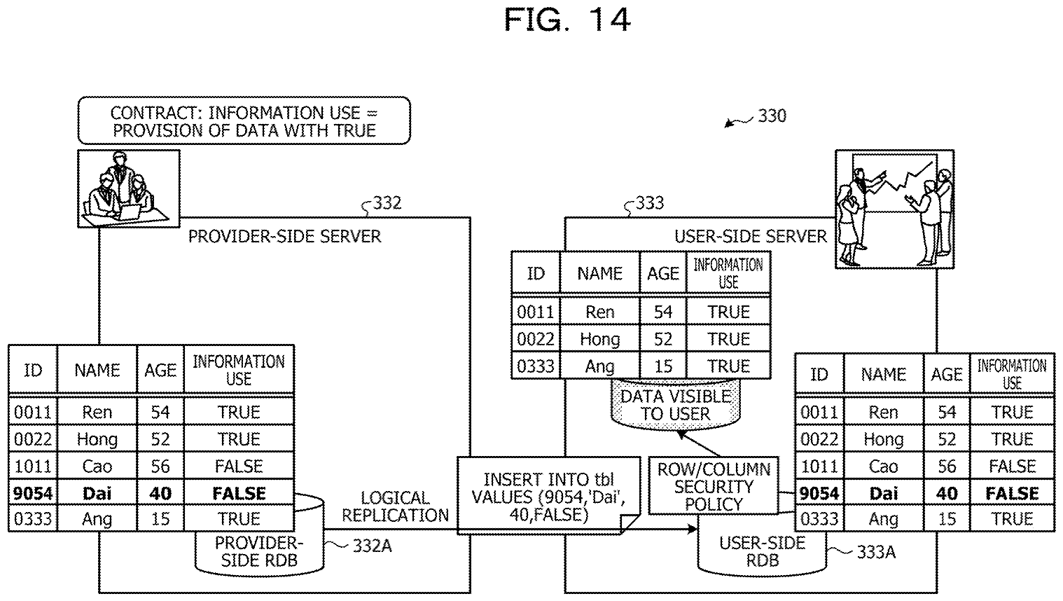

Thus, to cope with such a situation, a fourth data provision system 330 that has both the logical replication function and the filtering function while the processing load is reduced is conceivable. FIG. 14 is an explanatory diagram illustrating an example of the fourth data provision system 330.

In the fourth data provision system 330, filtering is not performed, but a situation may be realized where data actually exists but is not visible by using a security policy in units of rows and in units of columns of a database at a replication destination.

The fourth data provision system 330 illustrated in FIG. 14 has a provider-side server 332 having a provider-side RDB 332A, and a user-side server 333 having a user-side RDB 333A. The user-side RDB 333A also stores a copy of data of the provider-side RDB 332A.

When new data, for example, data with the ID “9054”, name “Dai”, age “40”, and information use “FALSE” is added in the provider-side RDB 332A, the provider-side server 332 transmits insertion log information to the user-side server 333. The provider-side server 332 defines policy information indicating that a reference may be made to the data with the information use “TRUE” stored in the user-side RDB 333A on a user-side server 333 side, and no reference may be made to the data with the information use “FALSE”. The provider-side server 332 transmits the policy information to the user-side server 333.

The user-side server 333 registers insertion new data in the user-side RDB 333A based on the insertion log information received from the provider-side server 332. The user-side server 333 sets a state, based on the policy information received from the provider-side server 332, in which among the data stored in the user-side RDB 333A, a reference may be made to only the data with the information use “TRUE”, and no reference may be made to the data with the information use “FALSE”.

For example, in the user-side server 333, all the data in the provider-side RDB 332A is copied to the user-side RDB 333A by logical replication. In the user-side server 333, when a reference is actually made to the data stored in the user-side RDB 333A, since rows with the information use “FALSE” are masked based on the policy information in units of rows, the user may refer to only the data with the information use “TRUE”.

However, in the provider-side server 332 of the fourth data provision system 330, even the data to which no reference may be made in the user-side server 333 is stored in the user-side RDB 333A. Therefore, safety of data with the information use “FALSE” on the provider side is not secured.

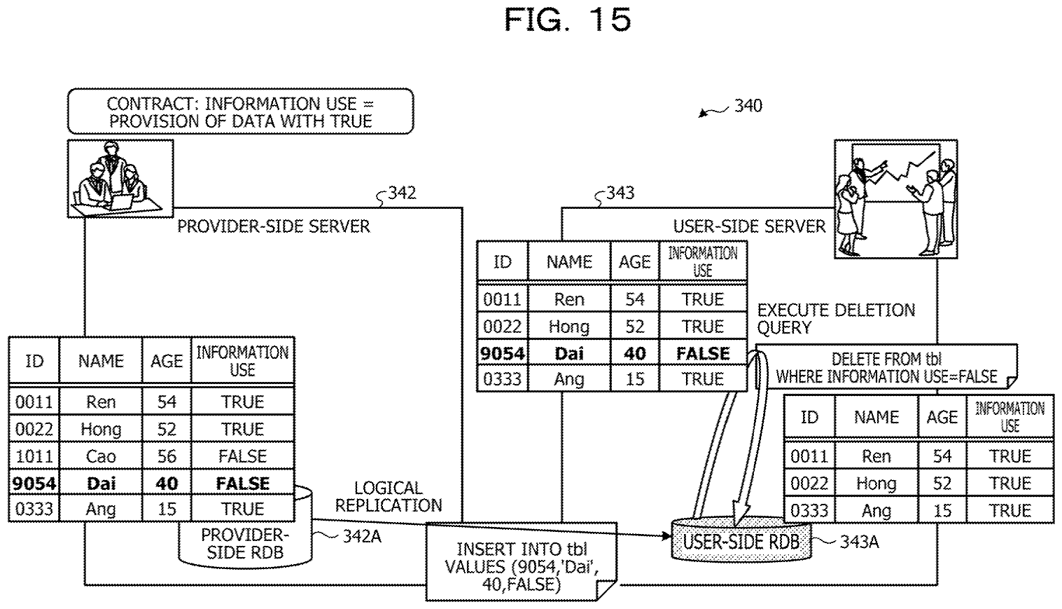

Thus, a fifth data provision system 340 that has both the logical replication and filtering functions while the safety of the data with the information use “FALSE” is secured is conceivable. FIG. 15 is an explanatory diagram illustrating an example of the fifth data provision system 340. The fifth data provision system 340 illustrated in FIG. 15 has a provider-side server 342 having a provider-side RDB 342A, and a user-side server 343 having a user-side RDB 343A. The user-side RDB 343A also stores a copy of data of the provider-side RDB 342A.

When new data, for example, data with the ID “9054”, name “Dai”, age “40”, and information use “FALSE” is added in the provider-side RDB 342A, the provider-side server 342 transmits insertion log information to the user-side server 343. The provider-side server 342 transmits a deletion query for deleting the data with the information use “FALSE” in the user-side RDB 343A to the user-side server 343.

When the insertion log information is received, the user-side server 343 registers insertion new data in the user-side RDB 343A based on the insertion log information. For example, the user-side server 343 registers the data with the ID “9054”, name “Dai”, age “40”, and information use “FALSE” in the user-side RDB 343A. Next, when the deletion query is received, the user-side server 343 deletes the data with the information use “FALSE” in the user-side RDB 343A. For example, the user-side server 343 deletes the data with the ID “9054”, name “Dai”, and age “40” with the information use “FALSE” among data stored in the user-side RDB 343A according to the deletion query. For example, in the user-side server 343, all the data in the provider-side RDB 342A is copied to the user-side RDB 343A by logical replication, but the data with the information use “FALSE” is deleted from the user-side RDB 343A according to the deletion query. As a result, the user may refer to only referable data with the information use “TRUE” while the safety of the data with the information use “FALSE” is secured.

In the fifth data provision system 340, since the data with the information use “FALSE” is deleted according to the deletion query in the user-side RDB 343A, data contents of the provider-side RDB 342A and data contents of the user-side RDB 343A are different from each other.

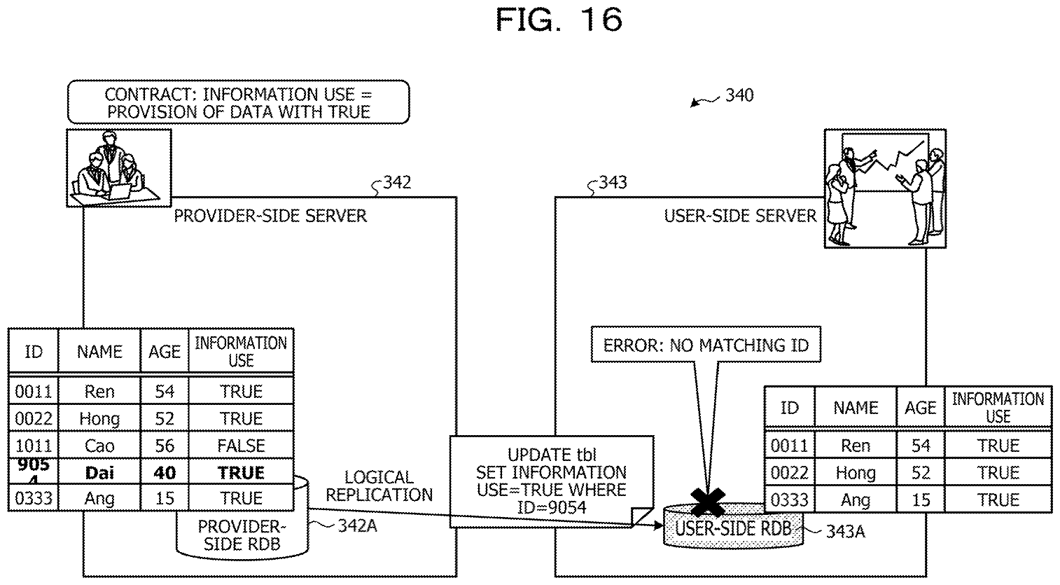

FIG. 16 is an explanatory diagram illustrating an example of an issue of the fifth data provision system 340. When the information use of the data stored in the user-side RDB 343A is updated from “FALSE” to “TRUE”, the provider-side server 342 transmits update log information to the user-side server 343. For example, when the information use “FALSE” of the data with the ID “9054”, name “Dai”, and age “40” is updated to “TRUE”, the update log information is transmitted to the user-side server 343.

However, even when the user-side server 343 receives the update log information for updating the information use from “FALSE” to “TRUE”, the data with the information use “FALSE” corresponding to the update log information is already deleted in the user-side RDB 343A. Since the information use is “FALSE” before the update in the user-side server 343, for example, the data with the ID “9054”, name “Dai”, and age “40” is deleted from the user-side RDB 343A. Therefore, regarding the user-side server 343, since the data matching with ID “9054” is absent in the user-side RDB 343A, the data with the ID “9054” is not updated in the user-side RDB 343A, and a logical replication error occurs. As a result, the data with the information use “TRUE” is not registered in the user-side RDB 343A, and the provider does not provide the data with the information use “TRUE” to the user.

For example, a system is demanded with which while safety of update data for the provider-side RDB 342A is secured, the update data may be reflected in the user-side RDB 343A.

Hereinafter, with reference to the drawings, embodiments of a technology are described in detail with which while safety of update data for a database at a data supply source is secured, the update data may be reflected in a database at a data supply destination. It is noted that respective embodiments do not limit the disclosed technology. The following respective embodiments may be combined as appropriate in a range without involving contradictions.

[First Embodiment]

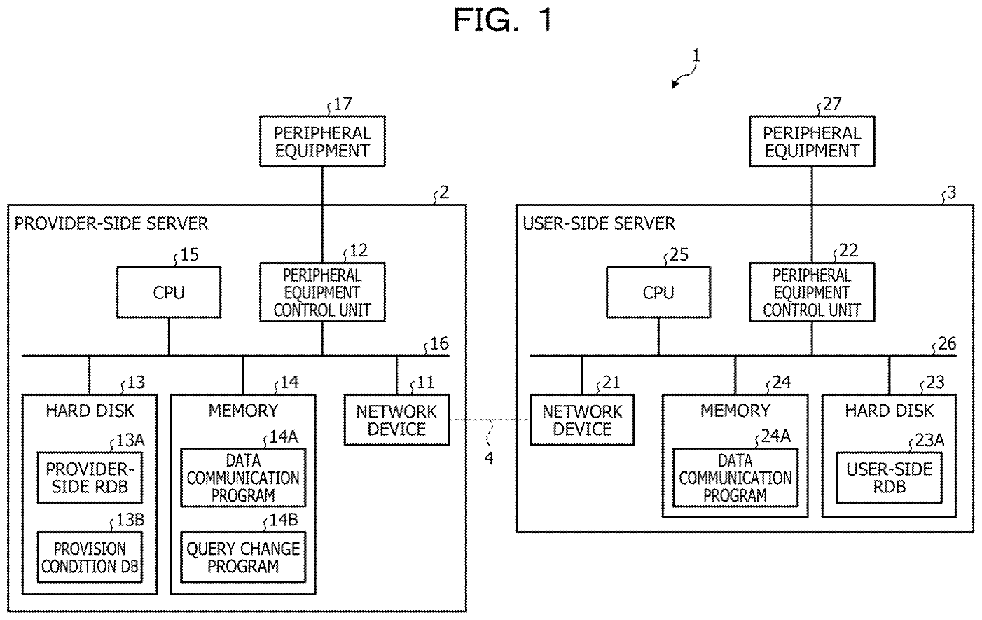

FIG. 1 is an explanatory diagram illustrating an example of a data provision system 1 according to First Embodiment. The data provision system 1 illustrated in FIG. 1 has a provider-side server 2 and a user-side server 3. The provider-side server 2 is a provider-side computer that provides data. The user-side server 3 is a user-side computer that uses the data provided from the provider-side server.

The provider-side server 2 has a network device 11, a peripheral equipment control unit 12, a hard disk 13, a memory 14, a central processing unit (CPU) 15, and a bus 16. The network device 11 is an interface (IF) that governs communication with the user-side server 3. For example, the peripheral equipment control unit 12 controls peripheral equipment 17 such as a user operation unit 17A such as a keyboard and a mouse, a display, and the like. The hard disk 13 is an area where various data and the like are stored. The memory 14 is an area where various programs and the like are stored. The CPU 15 controls the entirety of the provider-side server 2. The bus 16 is a bus line that couples the network device 11, the peripheral equipment control unit 12, the hard disk 13, the memory 14, and the CPU 15.

The hard disk 13 has a provider-side relational database (RDB) 13A and a provision condition database (DB) 13B. The provider-side RDB 13A is, for example, a DB that manages provision target data in units of rows or in units of columns. The provision condition DB 13B is a DB that manages conditions related to data provision between the provider and the user.

The memory 14 stores a data communication program 14A and a query change program 14B. The data communication program 14A is a program for executing communication with the user-side server 3. The query change program 14B is a program for changing a query of data for the provider-side RDB 13A to a query corresponding to the user-side RDB 23A.

The user-side server 3 has a network device 21, a peripheral equipment control unit 22, a hard disk 23, a memory 24, a CPU 25, and a bus 26. The network device 21 is an IF that governs communication with the provider-side server 2. For example, the peripheral equipment control unit 22 controls peripheral equipment 27 such as a user-side operation unit 27A such as a keyboard and a mouse, a display, and the like. The hard disk 23 is an area where various data and the like are stored. The memory 24 is an area where various programs and the like are stored. The CPU 25 controls the entirety of the user-side server 3. The bus 26 is a bus line that couples the network device 21, the peripheral equipment control unit 22, the hard disk 23, the memory 24, and the CPU 25.

The hard disk 23 has a user-side RDB 23A. The user-side RDB 23A is, for example, a DB that manages user-side data in unit of rows or in unit of columns. The memory 24 stores a data communication program 24A. The data communication program 24A is a program for executing communication with the provider-side server 2.

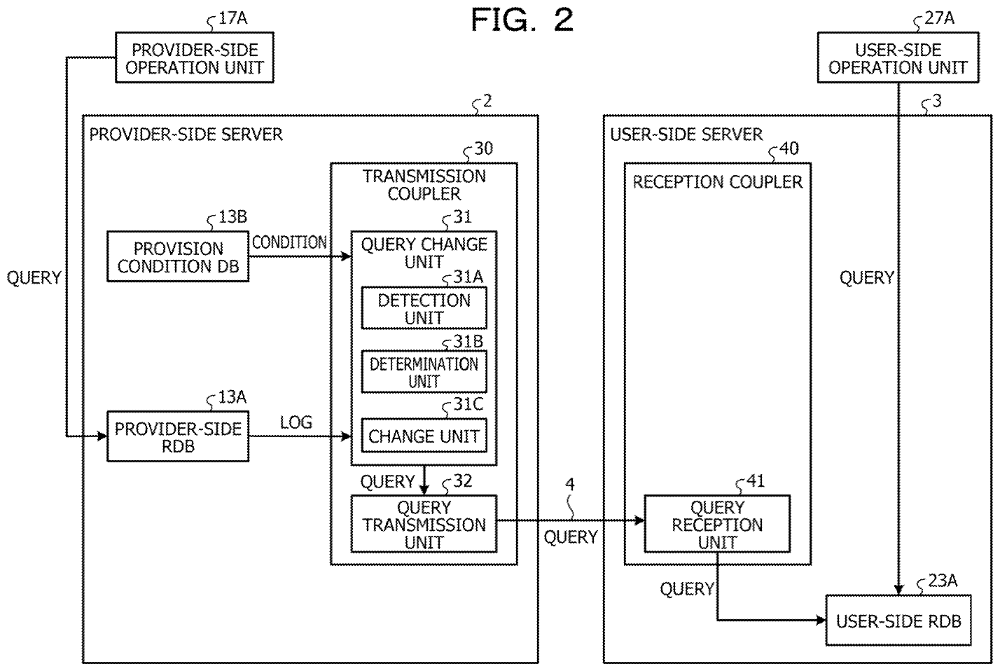

FIG. 2 is a block diagram illustrating an example of a functional configuration of the provider-side server 2 and the user-side server 3 with reference to FIG. 1. The CPU 15 of the provider-side server 2 has a query change unit 31 that reads the query change program 14B in the memory 14 and executes the read query change program 14B to execute query change of a transmission coupler 30. The CPU 15 of the provider-side server 2 has a query transmission unit 32 that reads the data communication program 14A in the memory 14 and executes the data communication program 14A to execute query transmission of the transmission coupler 30.

The query change unit 31 changes a query for data in the provider-side RDB 13A to a query corresponding to the user-side RDB 23A. For example, the query is a request for new insertion of data in the provider-side RDB 13A, a request for deletion or update of data in the provider-side RDB 13A, and the like. The query transmission unit 32 transmits the query to the user-side RDB 23A which is changed by the query change unit 31 to the user-side server 3.

The query change unit 31 has a detection unit 31A, a determination unit 31B, and a change unit 31C. The detection unit 31A detects data update in the provider-side RDB 13A corresponding to a data supply source DB. When data update in the provider-side RDB 13A is detected, the determination unit 31B determines whether or not update target data after the update is an access control target. For example, the access control target is data satisfying a provision condition that the data may be provided to the user on the provider side. The change unit 31C changes a query related to the update target data output to the user-side RDB 23A corresponding to a data supply destination DB based on a determination result.

When data update in the provider-side RDB 13A is detected, the determination unit 31B determines whether or not the update target data already exists in the user-side RDB 23A and also is an access control target satisfying a predetermined provision condition. When the update target data is the access control target, the change unit 31C outputs an update query for updating the update target data to the user-side RDB 23A. When the update target data is not the access control target, the change unit 31C changes the data update query to a deletion query for deleting the update target data from the user-side RDB 23A.

When the data update in the provider-side RDB 13A is detected, the determination unit 31B determines whether or not the update target data does not exist in the user-side RDB 23A and also is the access control target satisfying the predetermined provision condition. When the update target data is the access control target, the change unit 31C changes the data update query to an insertion query for inserting the update target data to the user-side RDB 23A.

When data insertion to the provider-side RDB 13A is detected, the determination unit 31B determines whether or not the insertion target data is an access control target. When the insertion target data is the access control target, the change unit 31C outputs an insertion query for inserting insertion target data to the user-side RDB 23A. When the insertion target data is not the access control target, the change unit 31C does not output the insertion query.

When data deletion in the provider-side RDB 13A is detected, the determination unit 31B determines whether or not the deletion target data is an access control target that already exists in the user-side RDB 23A. When the deletion target data is the access control target, the change unit 31C outputs a deletion query for deleting the deletion target data to the user-side RDB 23A. When the deletion target data is not the access control target, the change unit 31C does not output the deletion query.

The CPU 25 of the user-side server 3 has a query reception unit 41 that reads the data communication program 24A in the memory 24 and executes the data communication program 24A to execute query reception of a reception coupler 40. The query reception unit 41 receives a query from the query transmission unit 32 in the provider-side server 2.

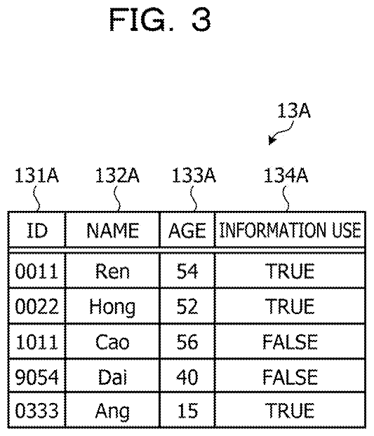

FIG. 3 is an explanatory diagram illustrating an example of a table configuration of the provider-side RDB 13A and the user-side RDB 23A. The provider-side RDB 13A illustrated in FIG. 3 is a DB that manages provision target data managed by the provider. The provider-side RDB 13A associates and manages IDs 131A, names 132A, ages 133A, and information use 134A. The ID 131A is an ID for identifying provision target data. The name 132A is a name for identifying a target person of the provision target data. The age 133A is an age of the target person of the provision target data. The information use 134A is an identifier for identifying whether or not information of the provision target data is usable to the user, for example, the provision target data is referable. The information use 134A is “TRUE” when the provision target data is referable, and is “FALSE” when the provision target data is not referable.

For example, the provider-side RDB 13A stores data with the ID “0011”, name “Ren”, age “54”, and information use “TRUE”. The provider-side

RDB 13A stores data with the ID “0022”, name “Hong”, age “52”, and information use “TRUE”, and data with the ID “1011”, name “Cao”, age “56”, and information use “FALSE”. For example, the provider-side RDB 13A stores data with the ID “9054”, name “Dai”, age “40”, and information use “FALSE”, and data with the ID “0333”, name “Ang”, age “15”, and information use “TRUE”.

The user-side RDB 23A manages data provided from the provider. For example, the user-side RDB 23A also manages data in which the ID, name, age, and information use similar to those of the provider-side RDB 13A are associated.

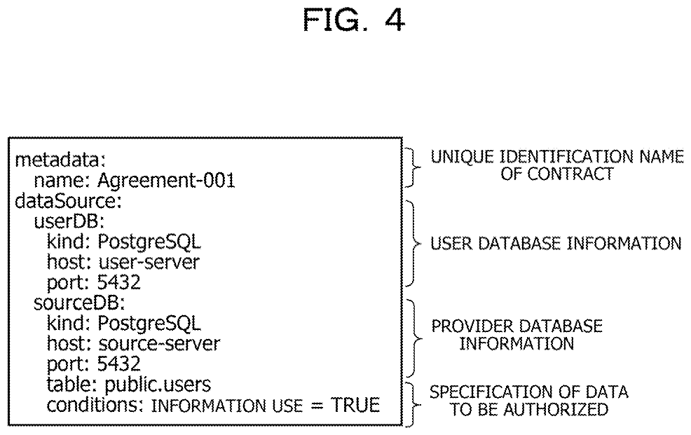

FIG. 4 is an explanatory diagram illustrating an example of a file of a provision condition. The file of the provision condition illustrated in FIG. 4 describes an identification name, user database information, provider database information, and specification of data to be authorized, in a yaml file method, for example. The method is not limited to the yaml file method, and may be appropriately changed. The identification name is a name for identifying a provision condition such as Agreement-001, for example. The user database information is, for example, information for identifying the user-side RDB 23A such as a host user-server. The provider database information is, for example, information for identifying the provider-side RDB 13A such as a table called public.users in the RDB referred to as PostgreSQL of a source-server host. The specification of the data to be authorized is a condition for providing data from the provider-side server 2 to the user-side server 3. The condition includes, for example, a case of the information use “TRUE”.

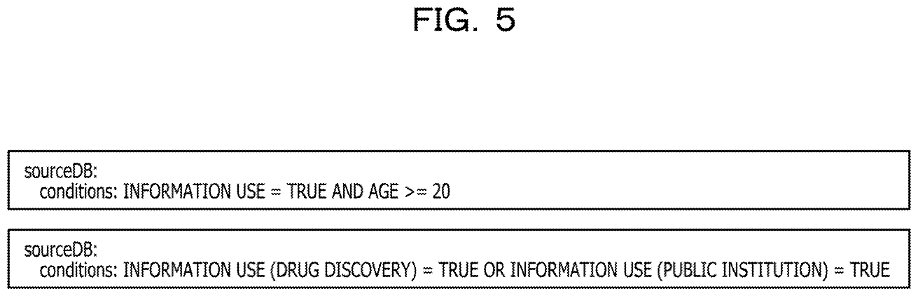

FIG. 5 is an explanatory diagram illustrating an example of a file of another specification of the data to be authorized. As the specification of the data to be authorized illustrated in FIG. 4, a single condition case where the information use is “TRUE” is exemplified. However, the condition is not limited to the single condition, but may also be multiple conditions. For example, data may be provided to the user when the information use is “TRUE” and the age is “20” or above. For example, multiple conditions may be specified such as a case where the information use is for drug discovery or for public institution, and the data may be provided to the user when the information use (drug discovery) is “TRUE”, or the information use (public institution) is “TRUE”.

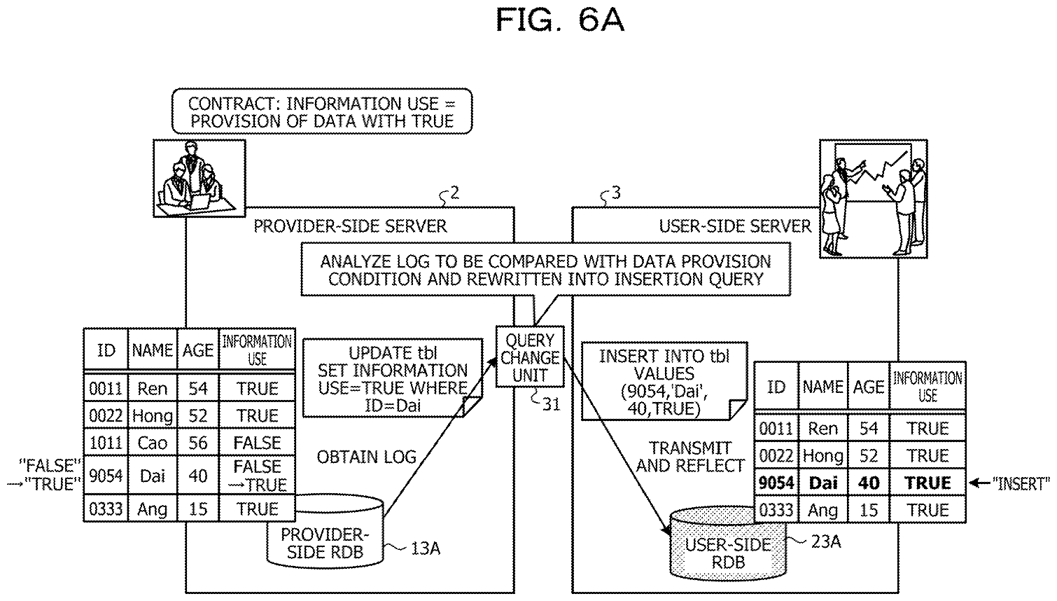

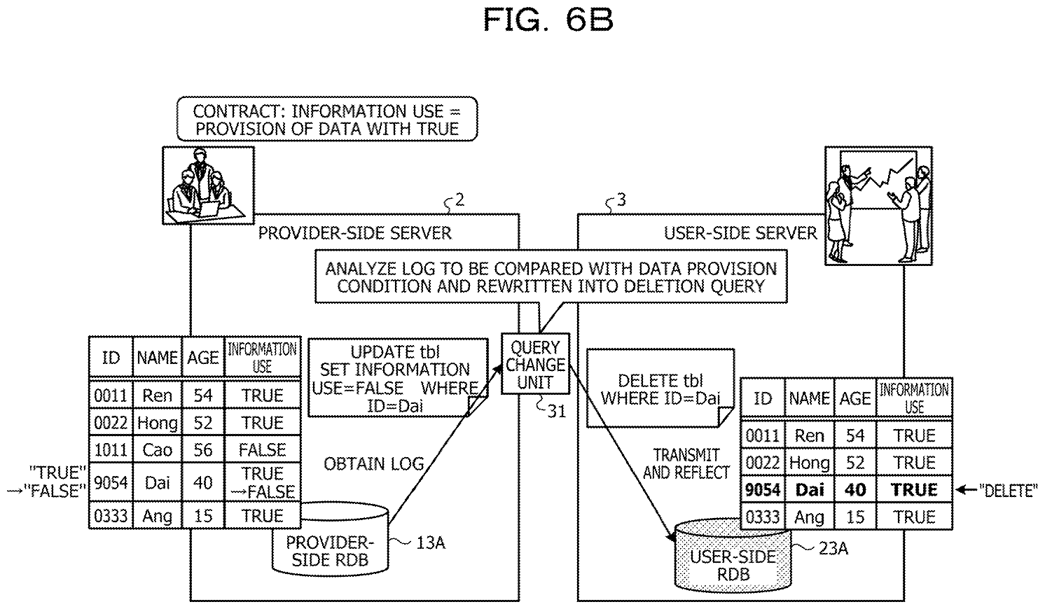

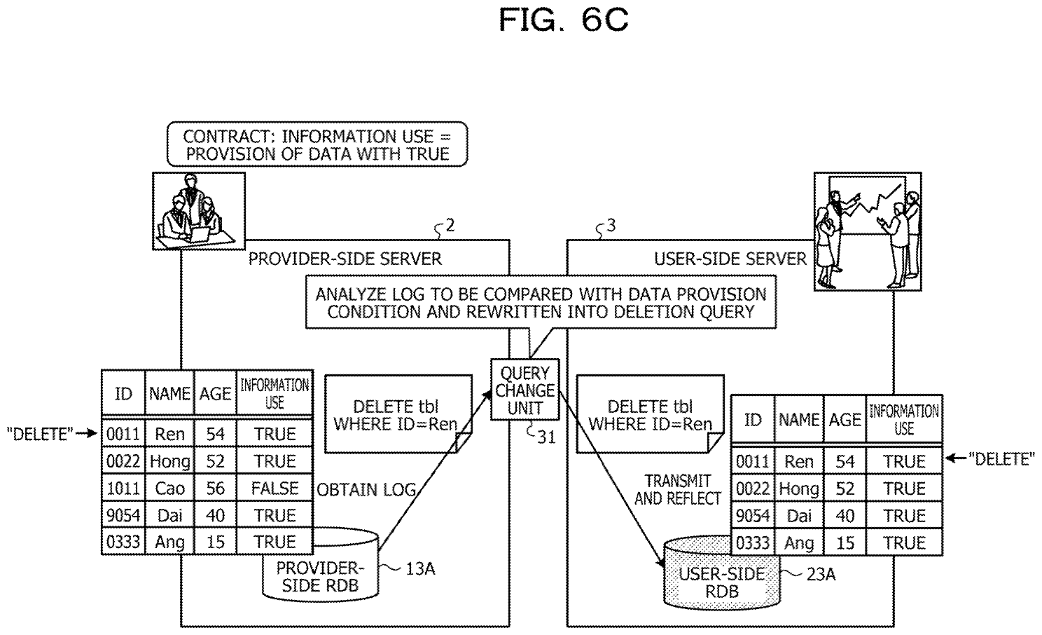

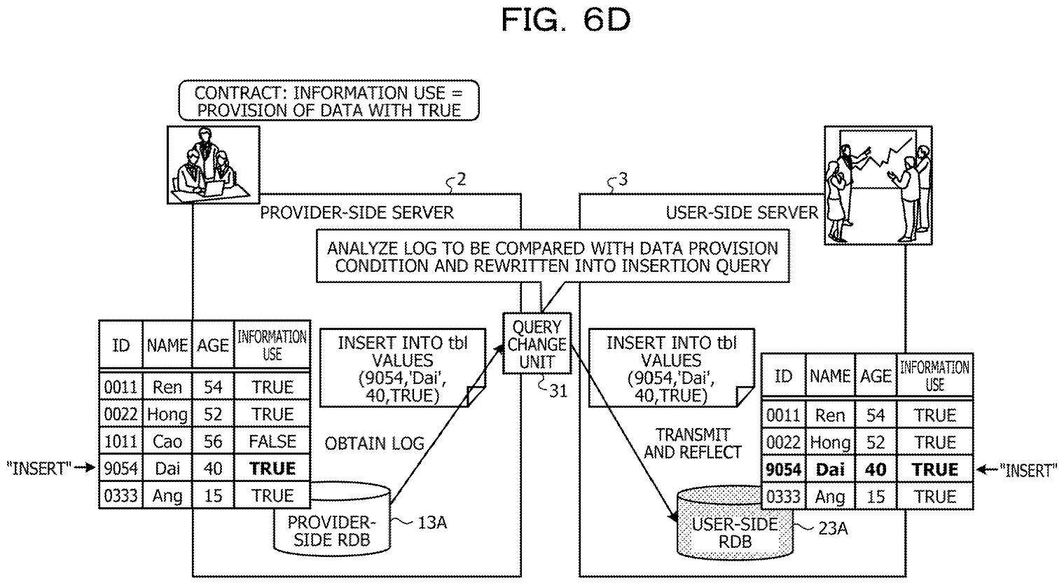

An operation of the data provision system 1 according to First Embodiment is described. FIG. 6A is an explanatory diagram illustrating an example of a query change operation when the information use (FALSE→TRUE) of the data provision system 1 is updated. For convenience of descriptions, a provision condition when data is provided from the provider-side server 2 to the user-side server 3 is the information use “TRUE”.

For example, the provider-side RDB 13A in the provider-side server 2 stores the data with the ID “0011”, name “Ren”, age “54”, and information use “TRUE”. The provider-side RDB 13A stores the data with the ID “0022”, and name “Hong”, age “52”, and information use “TRUE”, and the data with the ID “1011”, and name “Cao”, age “56”, and information use “FALSE”. For example, the provider-side RDB 13A stores data with the ID “9054”, name “Dai”, age “40”, and information use “FALSE”, and data with the ID “0333”, name “Ang”, age “15”, and information use “TRUE”.

For example, the user-side RDB 23A in the user-side server 3 stores the data with the ID “0011”, name “Ren”, age “54”, and information use “TRUE”. The user-side RDB 23A stores the data with the ID “0022”, name “Hong”, age “52”, and information use “TRUE”, and the data with the ID “0333”, name “Ang”, age “15”, and information use “TRUE”.

At this time, in the provider-side server 2, for example, it is assumed that an update query for changing the information use “FALSE” of the data with the ID “9054”, name “Dai”, and age “40” in the provider-side RDB 13A to “TRUE” is requested. The update query is, for example, “UPDATE tbl, SET information use=TRUE, WHERE ID=Dai”.

The provider-side server 2 changes the information use “FALSE” of the data with the ID “9054”, name “Dai”, and age “40” in the provider-side RDB 13A to “TRUE” according to the update query.

When the update query for changing the information use of the data with the name “Dai” from “FALSE” to “TRUE” is detected, the query change unit 31 changes the update query to an insertion query since the information use satisfies the provision condition of “TRUE”. The insertion query after the change is, for example, “INSERT tbl, VALUES [9054, Dai, 40, TRUE]”. The query transmission unit 32 transmits the insertion query after the change to the user-side server 3.

When the insertion query is received from the provider-side server 2, the query reception unit 41 in the user-side server 3 inserts the data with the ID “9054”, name “Dai”, age “40”, and information use “TRUE” in the user-side RDB 23A.

When the update query for changing the information use of the data in the provider-side RDB 13A from “FALSE” to “TRUE” is detected, the query change unit 31 changes the update query to an insertion query. As a result, since the user-side server 3 may register the data changed to “TRUE” according to the insertion query in the user-side RDB 23A, the update data for the provider-side RDB 13A may be reflected in the user-side RDB 23A.

FIG. 6B is an explanatory diagram illustrating an example of the query change operation when the information use (TRUE→FALSE) of the data provision system 1 is updated. For convenience of descriptions, a provision condition when data is provided from the provider-side server 2 to the user-side server 3 is the information use “TRUE”.

For example, the provider-side RDB 13A in the provider-side server 2 stores the data with the ID “9054”, name “Dai”, age “40”, and information use “TRUE”. For example, the user-side RDB 23A in the user-side server 3 also stores the data with the ID “9054”, name “Dai”, age “40”, and information use “TRUE”.

At this time, in the provider-side server 2, for example, it is assumed that an update query for changing the information use “TRUE” of the data with the ID “9054”, name “Dai”, and age “40” in the provider-side RDB 13A to “FALSE” is requested. The update query at this time is, for example, “UPDATE tbl, SET information use=FALSE, WHERE ID=Dai”.

The provider-side server 2 changes the information use of the data with the ID “9054”, name “Dai”, and age “40” in the provider-side RDB 13A from “TRUE” to “FALSE” according to the update query.

When the update query for changing the information use of the data with the name “Dai” from “TRUE” to “FALSE” is detected, the query change unit 31 changes the update query to a deletion query since the information use does not satisfies a provision condition of “FALSE”. The deletion query after the change is, for example, “DELETE tbl, WHERE ID=Dai”. The query transmission unit 32 transmits the deletion query after the change to the user-side server 3.

When the deletion query is received from the provider-side server 2, the query reception unit 41 in the user-side server 3 deletes the data with the ID “9054”, name “Dai”, age “40”, and information use “TRUE” in the user-side RDB 23A.

When the update query for changing the information use of the data in the provider-side RDB 13A from “TRUE” to “FALSE” is detected, the query change unit 31 changes the update query to a deletion query. As a result, since the data changed to “FALSE” according to the deletion query is deleted from the user-side RDB 23A, the user-side server 3 reflects the update data for the provider-side RDB 13A in the user-side RDB 23A. The provider may secure the safety of the data to which no reference may be made for the user.

FIG. 6C is an explanatory diagram illustrating an example of the query change operation when data is deleted in the data provision system 1. For convenience of descriptions, a provision condition when data is provided from the provider-side server 2 to the user-side server 3 is the information use “TRUE”.

For example, the provider-side RDB 13A in the provider-side server 2 stores the data with the ID “0011”, name “Ren”, age “54”, and information use “TRUE”. For example, the user-side RDB 23A in the user-side server 3 also stores the data with the ID “0011”, name “Ren”, age “54”, and information use “TRUE”.

At this time, for example, in the provider-side server 2, a deletion query for deleting the data with the ID “0011”, name “Ren”, age “54”, and information use “TRUE” is requested from the provider-side RDB 13A. At this time, the deletion query is, for example, “DELETE tbl, WHERE ID=Ren”.

The provider-side server 2 deletes the data with the ID “0011”, name “Ren”, age “54”, and information use “TRUE” in the provider-side RDB 13A according to the deletion query.

When the deletion query for deleting the data with the ID “0011”, name “Ren”, age “54”, and information use “TRUE” in the provider-side RDB 13A, the query change unit 31 outputs the deletion query. At this time, the deletion query is, for example, “DELETE tbl, WHERE ID=Ren”. The query transmission unit 32 transmits the deletion query after the change to the user-side server 3.

When the deletion query is received from the provider-side server 2, the query reception unit 41 in the user-side server 3 deletes the data with the ID “0011”, name “Ren”, age “54”, and information use “TRUE” from the user-side RDB 23A.

When a deletion query for deleting specified data in the provider-side RDB 13A is detected, the query change unit 31 requests the user-side server 3 for the deletion query. As a result, since the specific data from is deleted from the user-side RDB 23A, the user-side server 3 reflects the update data for the provider-side RDB 13A in the user-side RDB 23A. The provider may secure the safety of the data to which no reference may be made for the user.

FIG. 6D is an explanatory diagram illustrating an example of the query change operation when data is inserted in the data provision system 1. For convenience of descriptions, a provision condition when data is provided from the provider-side server 2 to the user-side server 3 is the information use “TRUE”.

For example, the provider-side RDB 13A in the provider-side server 2 stores the data with the ID “0011”, name “Ren”, age “54”, and information use “TRUE”, and the data with the ID “0022”, name “Hong”, age “52”, and information use “TRUE”. The provider-side RDB 13A stores the data with the ID “1011”, name “Cao”, age “56”, and information use “FALSE”, and the data with the ID “0333”, name “Ang”, age “15”, and information use “TRUE”.

For example, the user-side RDB 23A in the user-side server 3 stores the data with the ID “0011”, name “Ren”, age “54”, and information use “TRUE”, and the data with the ID “0022”, name “Hong”, age “52”, and information use “TRUE”. The user-side RDB 23A stores the data with the ID “0333”, name “Ang”, age “15”, and information use “TRUE”.

At this time, for example, in the provider-side server 2, an insertion query for inserting the data with the ID “9054”, name “Dai”, age “40”, and information use “TRUE” to the provider-side RDB 13A is requested. At this time, the insertion query is, for example, “INSERT INTO tbl, VALUES [9054, Dai, 40, TRUE]”.

For example, the provider-side server 2 inserts the data with the ID “9054”, name “Dai”, age “40”, and information use “TRUE” to the user-side RDB 23A according to the insertion query.

When the insertion query of the data with the name “Dai” and information use “TRUE” is detected, the query change unit 31 outputs the insertion query since the information use satisfies the provision condition of “TRUE”. At this time, the insertion query is, for example, “INSERT tbl, VALUES [9054, Dai, 40, TRUE]”. The query transmission unit 32 transmits the insertion query after the change to the user-side server 3.

When the insertion query is received from the provider-side server 2, the query reception unit 41 in the user-side server 3 inserts the data with the ID “9054”, name “Dai”, age “40”, and information use “TRUE” in the user-side RDB 23A.

When an insertion query of the data with the information use “TRUE” is detected, the query change unit 31 requests the user-side server 3 for the insertion query. As a result, since the user-side server 3 may register the data with the information use “TRUE” in the user-side RDB 23A, the update data for the provider-side RDB 13A may be reflected in the user-side RDB 23A. The provider may provide the referable data to the user.

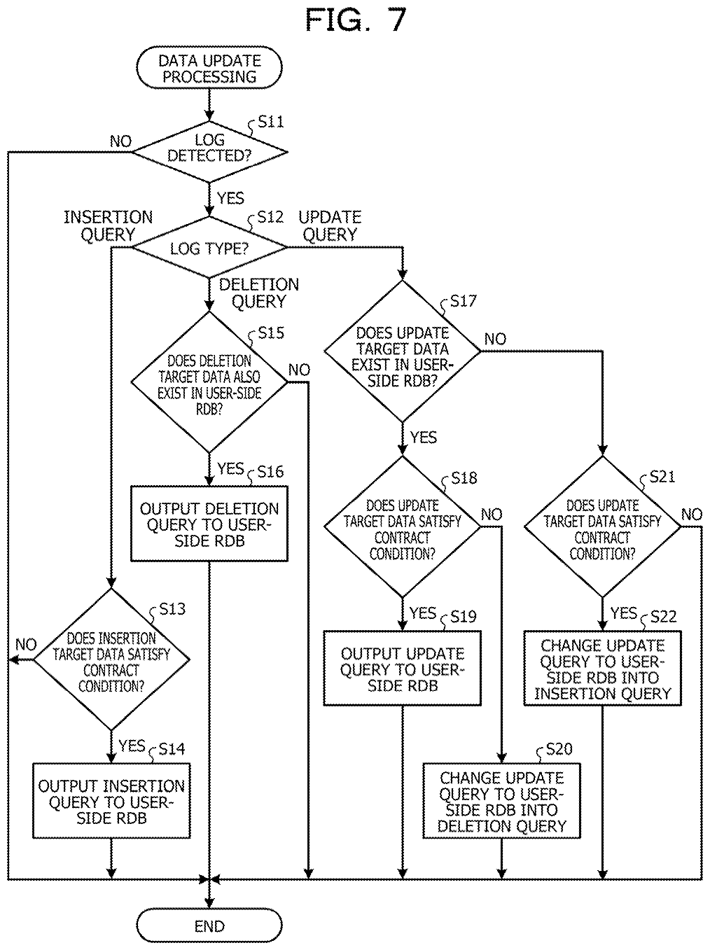

FIG. 7 is a flowchart illustrating an example of a processing operation of the query change unit 31 related to data update processing. The log type is, for example, a log such as an insertion query, a deletion query, or an update query. The insertion query is a query used when new insertion target data is inserted to the provider-side RDB 13A. The deletion query is a query used when deletion target data stored in the provider-side RDB 13A is deleted. The update query is a query used when a part of update target data stored in the provider-side RDB 13A is updated. The provision condition refers to a condition where the data with information use “TRUE” among the data in the provider-side RDB 13A is provided to the user, for example.

In FIG. 7, the detection unit 31A in the query change unit 31 of the provider-side server 2 determines whether or not a log to the provider-side RDB 13A is detected (operation S11). When the log to the provider-side RDB 13A is detected (operation S11: Yes), the detection unit 31A determines a log type (operation S12).

When the log type is an insertion query for inserting new insertion target data to the provider-side RDB 13A, the determination unit 31B in the query change unit 31 determines whether or not the insertion target data satisfies a provision condition (operation S13). For example, the determination unit 31B determines whether or not the information use of the data of the insertion target to the provider-side RDB 13A is “TRUE”.

When the insertion target data satisfies the provision condition (operation S13: Yes), for example, when the information use of the insertion target data is “TRUE”, the change unit 31C outputs an insertion query for inserting insertion target data to the user-side RDB 23A (operation S14). After the query change unit 31 transmits the insertion query through the query transmission unit 32 to the user-side server 3, the processing operation illustrated in FIG. 7 is ended. When the insertion target data does not satisfy the provision condition (operation S13: No), for example, when the information use of the insertion target data is “FALSE”, the determination unit 31B ignores the insertion query without inserting the insertion target data to the user-side RDB 23A, and the processing operation illustrated in FIG. 7 is ended.

When the log type is a deletion query for deleting the data stored in the provider-side RDB 13A, the determination unit 31B determines whether or not the deletion target data exists in the user-side RDB 23A (operation S15). When the deletion target data exists in the user-side RDB 23A (operation S15: Yes), the change unit 31C outputs a deletion query for deleting the deletion target data from the user-side RDB 23A (operation S16). After the query change unit 31 transmits the deletion query through the query transmission unit 32 to the user-side server 3, the processing operation illustrated in FIG. 7 is ended. When the deletion target data does not exist in the user-side RDB 23A (operation S15: No), the determination unit 31B ignores the deletion query, and the processing operation illustrated in FIG. 7 is ended.

When the log type is an update query for changing a part of the data stored in the provider-side RDB 13A, the determination unit 31B determines whether or not the update target data exists in the user-side RDB 23A (operation S17). When the update target data exists in the user-side RDB 23A (operation S17: Yes), the determination unit 31B determines whether or not the update target data satisfies a provision condition (operation S18). For example, the determination unit 31B determines whether or not the information use of the update target data in the provider-side RDB 13A is “TRUE”.

When the update target data satisfies the provision condition (operation S18: Yes), for example, when the information use of the update target data is “TRUE”, the change unit 31C outputs an update query for updating the update target data in the user-side RDB 23A (operation S19). After the query change unit 31 transmits the update query through the query transmission unit 32 to the user-side server 3, the processing operation illustrated in FIG. 7 is ended. When the update target data does not satisfy the provision condition (operation S18: No), for example, the change unit 31C determines that the information use of the update target data is “FALSE”. When the information use of the update target data is “FALSE”, the change unit 31C changes the update query to a deletion query for deleting the update target data from the user-side RDB 23A (operation S20). After the query change unit 31 transmits the deletion query through the query transmission unit 32 to the user-side server 3, the processing operation illustrated in FIG. 7 is ended.

When the update target data does not exist in the user-side RDB 23A (operation S17: No), the determination unit 31B determines whether or not the update target data satisfies a provision condition (operation S21). The determination unit 318 determines whether or not the information use of the update target data in the provider-side RDB 13A is “TRUE”, for example.

When the update target data satisfies the provision condition (operation S21: Yes), for example, when the information use of the update target data is “TRUE”, the change unit 31C changes the update query to an insertion query for inserting the update target data to the user-side RDB 23A (operation S22). After the query change unit 31 transmits the insertion query through the query transmission unit 32 to the user-side server 3, the processing operation illustrated in FIG. 7 is ended. When the update target data does not satisfy the provision condition (operation S21: No), for example, when the information use of the update target data is “FALSE”, the query change unit 31 ends the processing operation illustrated in FIG. 7 without inserting the update target data to the user-side RDB 23A.

When insertion target data of the insertion query satisfies the provision condition, for example, when the information use of the insertion target data is “TRUE”, the query change unit 31 outputs the insertion query for inserting the insertion target data to the user-side RDB 23A to the user-side server 3. As a result, even when the insertion query is generated in the provider-side RDB 13A, the insertion target data may be inserted into the user-side RDB 23A.

When the insertion target data of the insertion query does not satisfy the provision condition, for example, when the information use of the insertion target data is “FALSE”, the query change unit 31 inserts the insertion target data to only the provider-side RDB 13A. As a result, the provider-side RDB 13A may add and register the insertion target data. The provider may secure the safety of the insertion target data for the user-side server 3.

When the deletion target data of the deletion query exists in the user-side RDB 23A, the query change unit 31 outputs the deletion query for deleting the deletion target data from the user-side RDB 23A to the user-side server 3. As a result, even when the deletion query is generated in the provider-side RDB 13A, the deletion target data may be deleted from the user-side RDB 23A.

When the update target data of the update query exists in the user-side RDB 23A and also the update target data satisfies the provision condition, for example, when the information use of the update target data is “TRUE”, the query change unit 31 outputs the update query. The query change unit 31 transmits the update query to the user-side server 3. As a result, even when the update query of the update target data with the information use “TRUE” is generated in the provider-side RDB 13A, the update target data with the information use “TRUE” may be updated in the user-side RDB 23A.

When the update target data of the update query exists in the user-side RDB 23A and also the update target data does not satisfy the provision condition, for example, when the information use of the update target data is “FALSE”, the query change unit 31 changes the update query to a deletion query. The query change unit 31 transmits the deletion query to the user-side server 3. As a result, even when the update query of the update target data with the information use “FALSE” is generated in the provider-side RDB 13A, the update target data with the information use “FALSE” may be deleted from the user-side RDB 23A. The provider may secure the safety of the update target data for the user-side server 3.

When the update target data of the update query does not exist in the user-side RDB 23A and also the update target data satisfies the provision condition, for example, when the information use of the update target data is “TRUE”, the query change unit 31 changes the update query to an insertion query. The query change unit 31 transmits the insertion query to the user-side server 3. As a result, even when the update query of the update target data with the information use “TRUE” is generated in the provider-side RDB 13A, the update target data with the information use “TRUE” may be inserted to the user-side RDB 23A.

When data update in the provider-side RDB 13A is detected, the provider-side server 2 of First Embodiment determines whether or not update target data after the update is an access control target. The provider-side server 2 changes the query of the update target data for the user-side RDB 23A based on the determination result. As a result, while the safety of the update data for the provider-side RDB 13A is secured, the update data may be securely reflected in the user-side RDB 23A.

When data update in the provider-side RDB 13A is detected, the provider-side server 2 determines whether or not the update target data already exists in the user-side RDB 23A and also is an access control target satisfying a predetermined provision condition. When the update target data is the access control target, the provider-side server 2 outputs an update query of data update to the user-side RDB 23A. As a result, while the safety of the update data for the provider-side RDB 13A is secured, the update data may be reflected in the user-side RDB 23A.

When the update target data is not the access control target, the provider-side server 2 changes the data update query to a deletion query for the user-side RDB 23A. As a result, while the safety of the update data for the provider-side RDB 13A is secured, the update data may be reflected in the user-side RDB 23A.

When data update in the provider-side RDB 13A is detected, the provider-side server 2 determines whether or not the update target data does not exist in the user-side RDB 23A and also is an access control target satisfying a predetermined provision condition. When the update target data is the access control target, the provider-side server 2 changes the data update query to an insertion query for the user-side RDB 23A. As a result, while the safety of the update data for the provider-side RDB 13A is secured, the update data may be reflected in the user-side RDB 23A.

When data deletion in the provider-side RDB 13A is detected, the provider-side server 2 determines whether or not deletion target data is an access control target already existing in the user-side RDB 23A. When the deletion target data is the access control target, the provider-side server 2 outputs a deletion query for deleting the deletion target data to the user-side RDB 23A. When the deletion target data is not the access control target, the provider-side server 2 does not output the deletion query to the user-side RDB 23A. As a result, while the safety of the update data for the provider-side RDB 13A is secured, the update data may be reflected in the user-side RDB 23A.

When data insertion to the provider-side RDB 13A is detected, the provider-side server 2 determines whether or not the insertion target data is an access control target. When the insertion target data is the access control target, the provider-side server 2 outputs an insertion query for inserting insertion target data to the user-side RDB 23A. When the insertion target data is not the access control target, the provider-side server 2 does not output the insertion query to the user-side RDB 23A. As a result, while the safety of the update data for the provider-side RDB 13A is secured, the update data may be reflected in the user-side RDB 23A.

According to First Embodiment, the query change mechanism in which the provision condition is reflected is included, and the data safety may be secured since the data that does not satisfy the provision condition is not provided to the user and the use is averted before the provision to the user. The update data in the provider-side RDB 13A may be reflected in the user-side RDB 23A.

For example, data is provided from the provider-side server 2 to the user-side server 3 every day, and when the number of pieces of data per day in the user-side RDB 23A is set as M rows (M pieces), the number of pieces of update data among the M pieces of data is set is assumed as N rows (N pieces). In this case, in the fifth data provision system 340 illustrated in FIG. 15, the amount of the data provided from the provider-side server 342 to the user-side server 343 is equivalent to the amount of the M pieces of data. In the data provision system 1 of the present embodiment, when the data is provided from the provider-side server 2 to the user-side server 3, log information of at least the N pieces of update data is sufficient. Since the log information has data before and after the update, even when the data amount is assumed to be double the normal data, the amount of data provided from the provider-side server 2 to the user-side server 3 is set as 2N/M. Therefore, efficiency for transmitting the data from the provider-side server 2 to the user-side server 3 of First Embodiment is higher as the number of M rows is higher and the number of N rows is lower. For example, when 1000 entries of data are updated per day among 1 million entries of provided data, the transmission data amount is only 0.002 times as high as the transmission data amount of the fifth data provision system 340 of FIG. 15. For example, when 1000 entries of data are updated per day among 5000 entries of provided data, the transmission data amount is only 0.4 times as high as the transmission data amount of the fifth data provision system 340.

According to First Embodiment, a case is exemplified where the provider-side server 2 is realized by a computer, and the user-side server 3 is realized by a computer, but the provider-side server 2 and the user-side server 3 may be realized by virtualization in a single computer, and may be appropriately changed.

In the data provision system 1 of First Embodiment, a one-to-one system that provides the data according to the provision condition from the provider-side server 2 to the user-side server 3 is exemplified. However, an embodiment may be applied to a multi-to-multi system that provides the data according to the provision condition from multiple provider-side servers 2 to multiple user-side servers 3, and the embodiment is described as Embodiment 2 below.

[Second Embodiment]

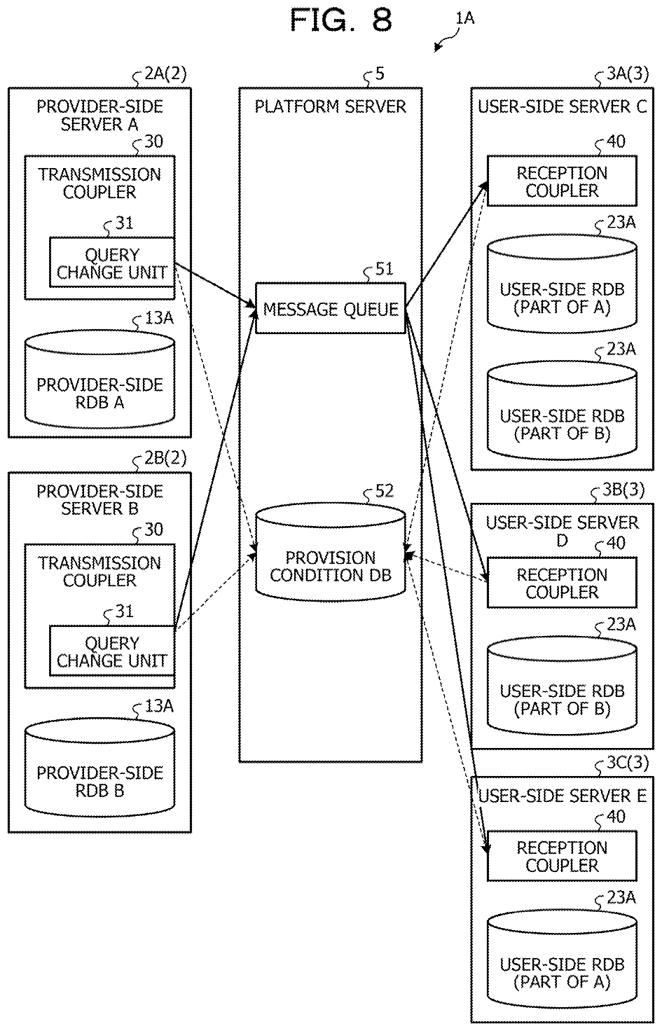

FIG. 8 is an explanatory diagram illustrating an example of a data provision system 1A according to Second Embodiment. The data provision system 1A illustrated in FIG. 8 has the multiple provider-side servers 2, the multiple user-side servers 3, and a platform server 5. For example, the multiple provider-side servers 2 have a provider-side server 2A and a provider-side server 2B. For example, the multiple user-side servers 3 have a user-side server 3A, a user-side server 3B, and a user-side server 3C.

The platform server 5 has a message queue 51 for queuing of queries between the multiple provider-side servers 2 and the multiple user-side servers 3, and a provision condition DB 52. The provision condition DB 13B of First Embodiment manages the provision conditions in the provider-side server 2, but the provision condition DB 52 manages all the provision conditions in the platform server 5.

The query change unit 31 in each of the provider-side servers 2 obtains the provision condition in the provision condition DB 52, and determines whether or not update target data of an update query or insertion target data of an insertion query satisfies the provision condition.

The query change unit 31 obtains the provision condition from the platform server 5 when the insertion query is detected. When insertion target data of the insertion query satisfies the provision condition, for example, when the information use of the insertion target data is “TRUE”, the query change unit 31 outputs the insertion query for inserting the insertion target data to the user-side RDB 23A to the user-side server 3 via the message queue 51. As a result, even when the insertion query is generated in the provider-side RDB 13A, the insertion target data may be inserted into the user-side RDB 23A.

When the insertion target data of the insertion query does not satisfy the provision condition, for example, when the information use of the insertion target data is “FALSE”, the query change unit 31 inserts the insertion target data to only the provider-side RDB 13A. As a result, the provider-side RDB 13A may add and register the insertion target data. The provider may secure the safety of the insertion target data for the user-side server 3.

When the deletion target data of the deletion query exists in the user-side RDB 23A, the query change unit 31 outputs the deletion query for deleting the deletion target data from the user-side RDB 23A to the user-side server 3 via the message queue 51. As a result, even when the deletion query is generated in the provider-side RDB 13A, the deletion target data may be deleted from the user-side RDB 23A.

The query change unit 31 obtains the provision condition from the platform server 5 when the update query is detected. When the update target data of the update query exists in the user-side RDB 23A and also the update target data satisfies the provision condition, for example, when the information use of the update target data is “TRUE”, the query change unit 31 outputs the update query. The query change unit 31 transmits the update query to the user-side server 3 via the message queue 51. As a result, even when the update query of the update target data with the information use “TRUE” is generated in the provider-side RDB 13A, the update target data with the information use “TRUE” may be updated in the user-side RDB 23A.

When the update target data of the update query exists in the user-side RDB 23A and also the update target data does not satisfy the provision condition, for example, when the information use of the update target data is “FALSE”, the query change unit 31 changes the update query to a deletion query. The query change unit 31 transmits the deletion query to the user-side server 3 via the message queue 51. As a result, even when the update query of the update target data with the information use “FALSE” is generated in the provider-side RDB 13A, the update target data with the information use “FALSE” may be deleted from the user-side RDB 23A. The provider may secure the safety of the insertion target data for the user-side server 3.

The query change unit 31 obtains the provision condition from the platform server 5 when the update query is detected. When the update target data of the update query does not exist in the user-side RDB 23A and also the update target data satisfies the provision condition, for example, when the information use of the update target data is “TRUE”, the query change unit 31 changes the update query to an insertion query. The query change unit 31 transmits the insertion query to the user-side server 3 via the message queue 51. As a result, even when the update query of the update target data with the information use “TRUE” is generated in the provider-side RDB 13A, the update target data with the information use “TRUE” may be inserted to the user-side RDB 23A.

According to Second Embodiment, a case is exemplified where the multiple provider-side servers 2 and the multiple user-side servers 3 are coupled to each other by the platform server 5, and the platform server 5 is realized by a single computer. However, the multiple provider-side servers 2 and the multiple user-side servers 3 may be realized by virtualization in a single computer, and also the multiple provider-side servers 2, the multiple user-side servers 3, and the platform server 5 may be realized by virtualization in a single computer, and may be appropriately changed.

A case is exemplified where the provider-side RDB 13A manages data in association with the name, age, and information use for each ID, but the data contents may be appropriately changed. The managed data in the provider-side RDB 13A is not limited to personal information, and any data that may be provided to the user may be used, so that alterations may be appropriately made.

The components of respective parts illustrated in the drawings are not necessarily configured physically as illustrated in the drawings. For example, specific forms of dispersion and integration of the respective parts are not limited to those illustrated in the drawings, and all or part thereof may be configured by being functionally or physically dispersed or integrated in given units according to various loads, the state of use, and the like.

The whole or any part of various processing functions carried out in the respective apparatuses may be executed on a central processing unit (CPU), a digital signal processor (DSP), a field-programmable gate array (FPGA), or the like. The whole or any part of various processing functions may be executed on programs analyzed and executed by the CPU or the like or on hardware by a wired logic.

Areas for storing various information may be configured, for example, by a read-only memory (ROM), or a random-access memory (RAM) such as a synchronous dynamic random-access memory (SDRAM), a magnetoresistive random-access memory (MRAM), or a non-volatile random-access memory (NVRAM).

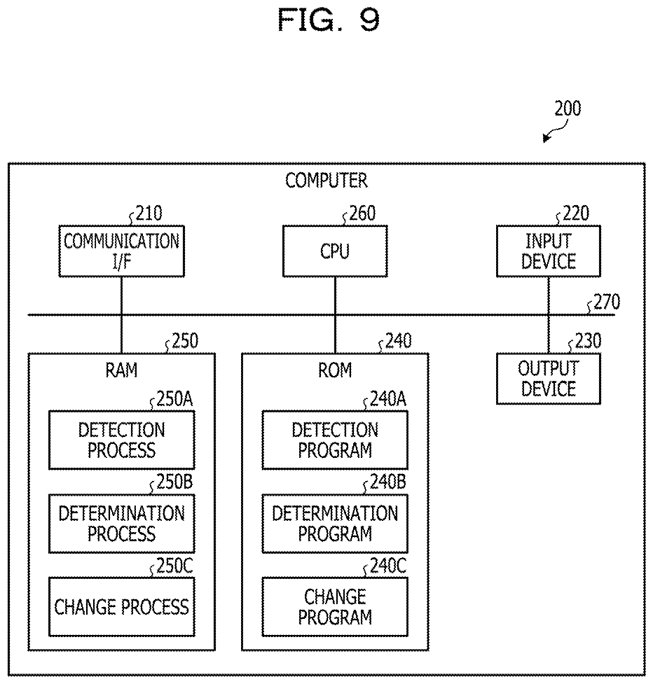

Various processes described in the present embodiment may be realized when a processor such as a CPU in a computer is caused to execute a previously prepared program. Thus, an example of a computer 200 that executes programs having functions similar to the aforementioned embodiment is described below. FIG. 9 is an explanatory diagram illustrating an example of the computer 200 that executes data update programs.

The computer 200 that executes the data update programs illustrated in FIG. 9 has a communication IF 210, an input device 220, an output device 230, a ROM 240, a RAM 250, a CPU 260, and a bus 270. The communication IF 210, the input device 220, the output device 230, the ROM 240, the RAM 250, and the CPU 260 are coupled via the bus 270. The RAM 250 is a database at a data supply source. The communication IF 210 governs communication with another computer that manages a database at a data supply destination.

The ROM 240 previously stores data update programs that exhibit functions similar to the functions of the aforementioned embodiments. The ROM 240 stores a detection program 240A, a determination program 240B, and a change program 240C as the data update programs. Instead of the ROM 240, a computer-readable recording medium by a drive that is not illustrated in the drawing may record a charge control program. Examples of the recording medium includes a compact disc (CD)-ROM, a Digital Versatile Disc (DVD) disk, a portable recording medium such as a Universal Serial Bus (USB) memory, a semiconductor memory such as a flash memory.

The CPU 260 reads the detection program 240A from the ROM 240 to function as a detection process 250A on the RAM 250. The CPU 260 reads the determination program 240B from the ROM 240 to function as a determination process 250B on the RAM 250. The CPU 260 reads the change program 240C from the ROM 240 to function as a change process 250C on the RAM 250.

When data update in the database at the data supply source is detected, the CPU 260 determines whether or not update target data after the update is an access control target. The CPU 260 changes a query related to the update target data which is output to the database at the data supply destination based on a determination result. As a result, the safety of the update data for the database at the data supply source is secured, the update data may be safely reflected in the database at the data supply destination.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored a program that causes a computer to execute a process, the process comprising:
determining, when an update of data in a first database of a data supply source is detected, whether or not first data of an update target after the update is second data of an access control target; and
changing a query related to the first data to be output to a second database of a data supply destination, based on a result of the determining.

2. The non-transitory computer-readable recording medium according to claim 1, wherein:
the determining includes, when the update in the first database is detected, determining whether or not the first data exists in the second database and is the second data that satisfies a predetermined provision condition, and
the changing includes, when the first data is the second data, outputting an update query for updating the first data to the second database.

3. The non-transitory computer-readable recording medium according to claim 2, wherein the changing includes, when the first data is not the second data, changing the update query to a deletion query for deleting the first data from the second database.

4. The non-transitory computer-readable recording medium according to claim 1, wherein:
the determining includes, when the update in the first database is detected, determining whether or not the first data does not exist in the second database and is the second data that satisfies a predetermined provision condition, and
the changing includes, when the first data is the second data, changing an update query for updating the first data to the second database to an insertion query for inserting the first data to the second database.

5. The non-transitory computer-readable recording medium according to claim 1, wherein:
the determining includes, when data, deletion in the first database is detected, determining whether or not third data of a deletion target is the second data that exists in the second database, and
the changing includes, when the third data is the second data, outputting a deletion query for deleting the third data to the second database, and when the third data is not the second data, not outputting the deletion query.

6. The non-transitory computer-readable recording medium according to claim 1, wherein:
the determining includes, when data insertion in the first database is detected, determining whether or not fourth data of an insertion target is the second data, and
the changing includes, when the fourth data is the second data, outputting an insertion query for inserting the fourth data to the second database, and when the fourth data is not the second data, not outputting the insertion query.

7. A data update apparatus comprising:
a memory: and
a processor coupled to the memory and configured to:
determine, when an update of data in a first database of a data supply source is detected, whether or not first data of an update target after the update is second data of an access control target; and
change a query related to the first data to be output to a second database of a data supply destination, based on a result of the determining.

8. A data update method that causes a computer to execute a process, the process comprising:
determining, when an update of data in a first database of a data supply source is detected, whether or not first data of an update target after the update is second data of an access control target; and
changing a query related to the first data to be output to a second database of a data supply destination, based on a result of the determining.
